(19) United States
(12) Patent Application Publication
(10) Pub. No.: US 2024/0177900 A1
(43) Pub. Date: May 30, 2024

(54) MAGNETIC BASE BODY, COIL COMPONENT PROVIDED WITH MAGNETIC BASE BODY, CIRCUIT BOARD PROVIDED WITH COIL COMPONENT, AND ELECTRONIC APPARATUS PROVIDED WITH CIRCUIT BOARD

(71) Applicant: Taiyo Yuden Co., Ltd., Tokyo (JP)

(72) Inventors: TOMOYA HAGIWARA, Tokyo (JP); TATSUYA TOMITA, Tokyo (JP); Takashi Nakajima, Tokyo (JP)

(21) Appl. No.: 18/509,413

(22) Filed: Nov. 15, 2023

(30) Foreign Application Priority Data
Nov. 29, 2022 (JP) 2022-190647

(51) Int. Cl. H01F 1/153; H01F 27/255

(52) U.S. Cl. CPC H01F 1/15341; H01F 27/255; H01F 27/2804

(57) ABSTRACT

Disclosed herein is a magnetic base body including a plurality of soft magnetic metal particles each containing Fe, and a plurality of insulation films that cover respective surfaces of the soft magnetic metal particles. The plurality of soft magnetic metal particles include a first soft magnetic metal particle, the plurality of insulation films include a first insulation film that covers a surface of the first soft magnetic metal particle, and the first insulation film is disposed between the first soft magnetic metal particle and a soft second magnetic metal particle that is adjacent to the first soft magnetic metal particle, and the first insulation film includes a first oxide region that is composed of mainly an amorphous Al oxide and a second oxide region that covers a portion of the surface of the first soft magnetic metal particle and that is composed of mainly an oxide of an element A.

### CROSS REFERENCE TO RELATED APPLICATIONS

This application claims priority benefit of Japanese Patent Application No. JP 2022-190647 filed in the Japan Patent Office on Nov. 29, 2022. Each of the above-referenced applications is hereby incorporated herein by reference in its entirety.

### BACKGROUND

The present disclosure mainly relates to a magnetic base body, a coil component provided with the magnetic base body, a circuit board provided with the coil component, and an electronic apparatus provided with the circuit board.

A coil component uses a soft magnetic base body containing a plurality of soft magnetic metal particles made of a soft magnetic material. A surface of each of the soft magnetic metal particles contained in the soft magnetic base body is coated with an insulation film. The adjacent soft magnetic metal particles are bonded to each other via the insulation films. Since the soft magnetic base body has a feature that magnetic saturation is less likely to occur than in a ferrite-made magnetic base body, the soft magnetic base body is suitable for use in a coil component used in a circuit in which a large electric current flows.

The soft magnetic metal particles are made from a magnetic material that is composed of mainly Fe, for example. Precursor powder for producing such Fe-base soft magnetic metal particles composed of mainly Fe, contains an additive element such as Si, Cr, or Al, in addition to Fe, in order to improve a magnetic property and an insulation property. The magnetic base body is produced by preparing a mixture resin composition formed of a mixture of resin and precursor powder made from a soft magnetic material and then heating the mixed resin composition. In the heating treatment, an additive element (e.g., Si, Cr, or Al) contained in a precursor powder particle moves to the surface of the precursor powder particle, and is oxidized. For this reason, an oxidized coating film that has an insulating property and contains an oxide of an element contained in precursor powder is formed on the surface of a soft magnetic metal particle. With the oxidized coating film, the adjacent soft magnetic metal particles are electrically insulated from each other.

The surface of each soft magnetic metal particle may be coated with a coating film having an insulation property. A glass or amorphous silicon oxide film is used as the coating film having an insulation property.

Thus, a coating film of an insulating oxide derived from an element contained in precursor powder or a coating film containing an insulating substance that is not derived from an element contained in precursor powder is formed on the surface of each soft magnetic metal particle.

Japanese Patent Laid-Open No. 2021-158261 discloses a magnetic base body including an insulation film that is obtained by layering four oxide layers on the surface of each soft magnetic metal particle. The magnetic base body of Japanese Patent Laid-Open No. 2021-158261 is produced by the following procedures. First, water atomization is performed to prepare precursor powder that has an Si oxide layer (first oxide layer) and an Fe oxide layer (second oxide layer) formed on the surface thereof. Next, a mixture liquid obtained by mixing tetraethoxysilane (TEOS) with ethanol is applied to the surface of the precursor powder, whereby a coating film is formed on the surface of the precursor powder. Subsequently, the surface of the precursor powder coated with the coating films is molded into a molded object, and heating treatment is performed on the molded object. Accordingly, a magnetic base body is obtained from the molded object. As a result of the heating treatment, the coating layer is turned into a third oxide layer that contains an Si oxide, and a fourth oxide layer that contains Fe is formed on the outer surface of the coating layer. Consequently, four oxide layers including the first to fourth oxide layers are formed on the surface of each soft magnetic metal particle contained in the magnetic base body which is obtained as a result of the heating treatment.

### SUMMARY

In a magnetic base body, adjacent soft magnetic metal particles are bonded to each other via insulation films formed on the respective surfaces thereof. For this reason, if the thickness of the insulation film formed on the surface of each soft magnetic metal particle contained in the magnetic base body is reduced, the contact area between the insulation films formed on the adjacent soft magnetic metal particles is reduced. In a case where the contact area between the insulation films formed on the adjacent soft magnetic metal particles is small, the bonding force between the adjacent soft magnetic metal particles which are bonded to each other via the insulation films is weak. This presents a problem that the mechanical strength of the resultant magnetic base body is deteriorated.

On the other hand, if the thickness of each

insulation film which is formed of a plurality of layered oxide layers is increased in order to increase the bonding force between the soft magnetic metal particles, the insulation film is uniformly thick in a circumferential direction of the soft magnetic metal particle. This presents a problem that the filling rate of the soft magnetic metal particles in the magnetic base body is significantly reduced.

It is desirable to solve or lessen at least a part of the above-mentioned problems. It is desirable to provide a magnetic base body in which the bonding strength between soft magnetic metal particles is improved while the filling rate of the soft magnetic metal particles is highly maintained.

The present technology will be disclosed in detail by the entire text in the description. The technology set forth in the claims may be provided to solve any problem other than the above-mentioned problems.

A magnetic base body according to one embodiment includes a plurality of soft magnetic metal particles each containing Fe, and a plurality of insulation films that cover respective surfaces of the plurality of soft magnetic metal particles. The plurality of soft magnetic metal particles include a first soft magnetic metal particle, and the plurality of insulation films include a first insulation film that covers a surface of the first soft magnetic metal particle. The first insulation film includes a first oxide region and a second oxide region. The first oxide region is disposed between the first soft magnetic metal particle and a second soft magnetic metal particle, and is composed of mainly an amorphous Al oxide. The second oxide region covers a portion of the surface of the first soft magnetic metal particle, and is composed of mainly an oxide of an element A.

According to an embodiment of the technology disclosed herein, a magnetic base body in which the bonding strength between soft magnetic metal particles is improved while the filling rate of the soft magnetic metal particles is highly maintained is obtained.

### BRIEF DESCRIPTION OF THE DRAWINGS

FIG. 1 is a schematic perspective view of a coil component including a magnetic composite according to one embodiment;

FIG. 2 is an exploded perspective view of the coil component in FIG. 1;

FIG. 3 is a schematic cross-sectional view of a cross section of the coil component taken along line I-I in FIG. 1;

FIG. 4 is a schematically enlarged cross-sectional view of a part of a cross section of a magnetic base body according to one embodiment;

FIG. 5 is a schematically enlarged cross-sectional view of a part of a cross section of a magnetic base body according to another embodiment;

FIG. 6 is a schematically enlarged cross-sectional view of a part of a cross section of a magnetic base body according to still another embodiment;

FIG. 7 is a schematically enlarged cross-sectional view of a part of a cross section of a magnetic base body according to yet another embodiment;

FIG. 8 is a flowchart depicting coil component production steps according to one embodiment of the present technology; and

FIG. 9 is a flowchart depicting coil component production steps according to another embodiment of the present technology.

### DETAILED DESCRIPTION OF THE PREFERRED EMBODIMENTS

Hereinafter, embodiments of the present technology will be explained with reference to the drawings as appropriate. The common constituent is denoted by the same reference numeral throughout the drawings. It is to be noted that, for the convenience of illustration, the scale in each drawing is not necessarily accurate. The following embodiments of the present technology are not necessarily intended to limit the technology set forth in the claims. The elements which will be explained in the following embodiments are not necessarily essential for the solution of the technology.

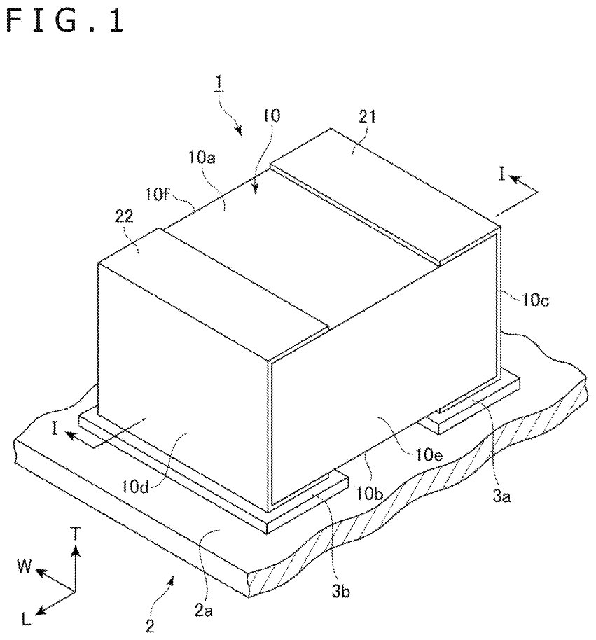

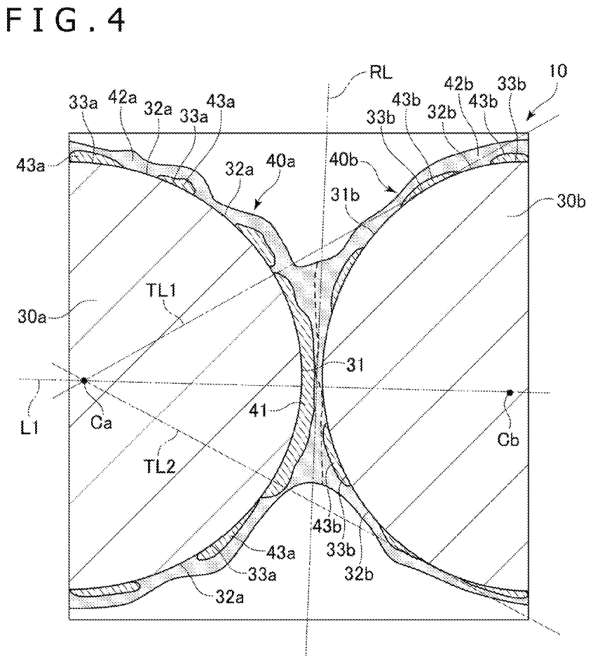

One embodiment disclosed herein pertains to a magnetic base body of a coil component. The magnetic base body contains a plurality of soft magnetic metal particles. In the following explanation, a coil component 1 that includes a magnetic base body according to the one embodiment will be explained first with reference to FIGS. 1 to 3, and then, the fine structure of the magnetic base body will be explained with reference to FIGS. 4 to 7.

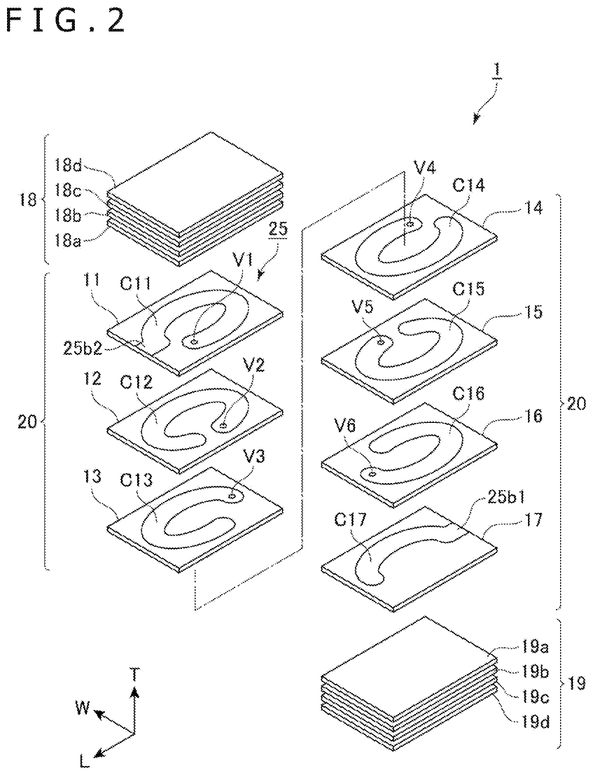

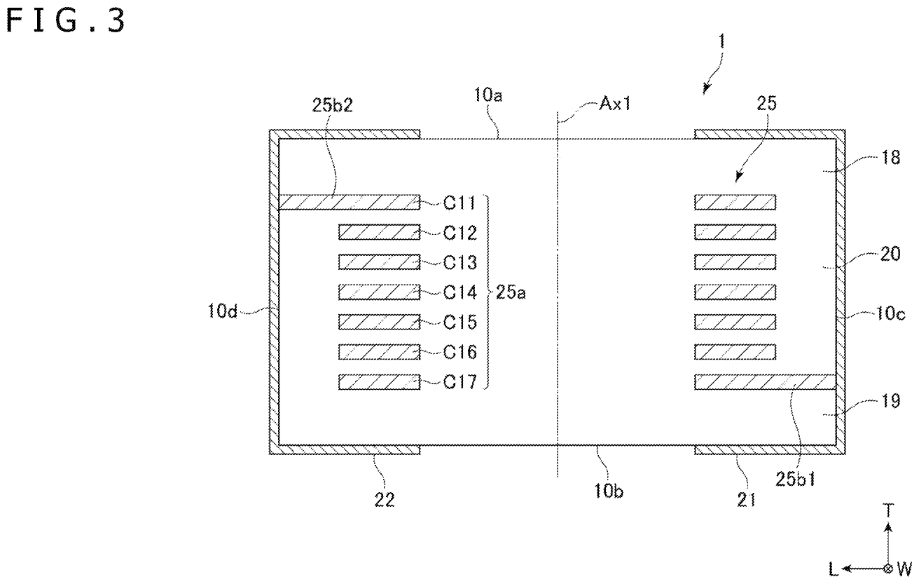

FIG. 1 is a schematic perspective view of the coil component 1. FIG. 2 is an exploded perspective view of the coil component 1. FIG. 3 is a schematic cross section of the coil component 1 taken along line I-I in FIG. 1. In FIG. 2, illustration of external electrodes is omitted for convenience of explanation.

FIGS. 1 to 3 each illustrate a lamination inductor as an example of the coil component 1. The illustrated lamination inductor is one example of the coil component 1 to which the present technology is applicable. The present technology is also applicable to a variety of coil components other than the lamination inductor. For example, the coil component 1 is applicable to winding coil components and planar coils.

As illustrated in the drawings, the coil component 1 includes a base body 10, a coil conductor 25 that is disposed inside the base body 10, an external electrode 21 that is disposed on a surface of the base body 10, and an external electrode 22 that is disposed, on the surface of the base body 10, separately from the external electrode 21. The base body 10 is a magnetic base body formed of a magnetic material. The base body 10 is an example of the “magnetic base body” set forth in the claims.

The base body 10 contains plenty of soft magnetic metal particles. The average particle diameter of the soft magnetic metal particles contained in the base body 10 is set to 1 to 20 μm, for example. The average particle diameter of the soft magnetic metal particles contained in the base body 10 is obtained by cutting the base body 10 along a thickness direction (T-axis direction) of the base body 10 to expose a cross section of the base body 10, obtaining a scanning electron microscope (SEM) image of the cross section with an SEM of approximately 10,000 to 50,000 magnification, obtaining the equivalent circle diameters (Heywood diameters) of the respective soft magnetic metal particles through an image analysis of the SEM image, and averaging the equivalent circle diameters of the respective soft magnetic metal particles. The average particle diameter of the soft magnetic metal particles contained in the base body 10 may be 1 to 10 μm, or may be 2 to 8 μm. The average particle diameter of the soft magnetic metal particles is not significantly different from the average particle diameter of the precursor powder. Therefore, the particle size distribution of the precursor powder may be measured by a laser diffraction scattering method conforming to JIS Z 8825, and a D50 value of the volume-based particle size distribution measured by the laser diffraction scattering method may be used as the average particle diameter of the soft magnetic metal particles contained in the base body 10.

The external electrode 21 is electrically connected to one end of the coil conductor 25, and the external electrode 22 is electrically connected to the other end of the coil conductor 25.

The coil component 1 can be mounted on a mounting board 2a. In the illustrated embodiment, land portions 3a and 3b are disposed on the mounting board 2a. The external electrode 21 is bonded to the land portion 3a, and the external electrode 22 is connected to the land portion 3b, whereby the coil component 1 is mounted on the mounting board 2a. A circuit board 2 according to the one embodiment of the present technology includes the coil component 1 and the mounting board 2a on which the coil component 1 is mounted. The circuit board 2 can be installed into a variety of electronic apparatuses. Examples of the electronic apparatuses into which the circuit board 2 can be installed include a smartphone, a tablet, a game console, an electrical component for automobiles, a server, and any other electronic apparatus.

The coil component 1 may be an inductor, a transformer, a filter, a reactor, an inductor array, or any other coil component. The coil component 1 may be a coupled inductor, a choke coil, or any other magnetic coupling type coil component. The use of the coil component 1 is not limited to those indicated herein.

In a case where the coil component 1 is an inductor array or a magnetic coupling type coil component, the coil conductor 25 is formed of two or more conductor sections. The two or more conductor sections of the coil conductor 25 are electrically insulated from each other in the base body 10.

In one embodiment, the base body 10 is formed in such a way that the L-axis dimension (length dimension) is larger than the W-axis dimension (width dimension) and the T-axis dimension (height dimension). For example, the length dimension falls within the range of 1.0 to 6.0 mm, the width dimension falls within the range of 0.5 to 4.5 mm, and the height dimension falls within the range of 0.5 to 4.5 mm. The dimensions of the base body 10 are not limited to the specific ones indicated in the present description. In the present description, the terms “rectangular parallelepiped” and “rectangular parallelopiped shape” do not necessarily mean a “rectangular parallelopiped” in the mathematically strict sense. The dimensions and the shape of the base body 10 are not limited to the specific ones indicated in the present description.

The base body 10 has a first main surface 10a, a second main surface 10b, a first end surface 10c, a second end surface 10d, a first side surface 10e, and a second side surface 10f. The outer surfaces of the base body 10 are defined by these six surfaces. The first main surface 10a and the second main surface 10b are surfaces on both ends in a height direction of the base body 10. The first end surface 10c and the second end surface 10d are surfaces on both ends in a length direction of the base body 10. The first side surface 10e and the second side surface 10f are surfaces on both ends in a width direction of the base body 10. As illustrated in FIG. 1, the first main surface 10a which is located on the upper side of the base body 10 may be referred to as an “upper surface” in the present description. Similarly, the second main surface 10b may be referred to as a “lower surface” or a “bottom surface.” The coil component 1 is placed with the second main surface 10b facing the mounting board 2a. Thus, the second main surface 10b may be referred to as a “mounting surface.” The upper surface 10a and the lower surface 10b are spaced apart by the height dimension of the base body 10. The first end surface 10c and the second end surface 10d are spaced apart by the length dimension of the base body 10. The first side surface 10e and the second side surface 10f are spaced apart by the width dimension of the base body 10.

As illustrated in FIG. 2, the base body 10 includes a main layer 20, a lower cover layer 19 that is disposed on the lower surface of the main layer 20, and an upper cover layer 18 that is disposed on the upper surface of the main layer 20. The upper cover layer 18, the lower cover layer 19, and the main layer 20 constitute the base body 10.

The main layer 20 includes magnetic films 11 to 17. In the main layer 20, the magnetic film 17, the magnetic film 16, the magnetic film 15, the magnetic film 14, the magnetic film 13, the magnetic film 12, and the magnetic film 11 are layered in this order from the negative side to the positive side in the T-axis direction.

Conductor patterns C11 to C17 are formed on the upper surfaces of the magnetic films 11 to 17, respectively. On a plane (LW plane) that is orthogonal to a coil axis Ax1 (see FIG. 3), the conductor patterns C11 to C17 extend around the coil axis Ax1. For example, the conductor patterns C11 to C17 are formed by performing screen printing of a conductive paste that is formed of metal or an alloy having excellent electrical conductivity. Ag, Pd, Cu, Al, or an alloy thereof ca be used as the material of the conductive paste. The conductive paste is prepared by kneading conductive powder which is formed of an excellently conductive material such as Ag, Pd, Cu, Al, or an alloy thereof with a binder resin and a solvent. The binder resin may be a polyvinyl chloride (PVC) resin, a phenol resin, any other publicly known binder resin, or a mixture thereof. In a case where Cu powder is used as the conductive powder, a thermally-decomposable resin such as an acrylic resin may be used as the binder resin in order to inhibit excessive oxidation of the Cu powder during degreasing. The thermally-decomposable resin can be decomposed without a combustion reaction with oxygen. Even in a non-oxygen atmosphere (e.g., nitrogen atmosphere), when the temperature of the thermally-decomposable resin is increased to the thermal decomposition temperature or higher, the thermally-decomposable resin is thermally decomposed and leaves no residue. Therefore, if the thermally-decomposable resin is used as the binder resin, degreasing can be performed in a non-oxygen atmosphere. For example, a (meth) acrylic acid copolymer, a (meth) acrylic acid-(meth) acrylic ester copolymer, a styrene-(meth) acrylic acid copolymer, or a styrene-(meth) acrylic acid-(meth) acrylic ester copolymer can be used as the acrylic resin for the conductive paste. Toluene, ethanol, terpineol, or a mixture thereof can be used as the solvent. The conductive paste can contain a regulating agent for regulating the thixotrophy property. The conductor patterns C11 to C17 may be formed of any other material by any other method. For example, the conductor patterns C11 to C17 may be formed by a sputtering method, an ink jet method, or any other publicly known method.

Vias V1 to V6 are formed in predetermined positions on the magnetic films 11 to 16, respectively. The vias V1 to V6 are formed by forming, in predetermined positions in the magnetic films 11 to 16, through holes to pass through the magnetic films 11 to 16 in the T-axis direction and by embedding a conductive material in the through holes. The conductor patterns C11 to C17 are electrically connected to adjacent conductor patterns through the vias V1 to V6.

An end, of the conductor pattern C11, opposite to an end connected to the via V1 is connected to the external electrode 22. An end, of the conductor pattern C17, opposite to an end connected to the via V6 is connected to the external electrode 21.

The upper cover layer 18 includes magnetic films 18a to 18d which are formed of a magnetic material. The lower cover layer 19 includes magnetic films 19a to 19d which are formed of a magnetic material. In the present description, the magnetic films 18a to 18d and the magnetic films 19a to 19d are collectively referred to as “cover layer magnetic films.” In addition, the constituents of the base body 10 do not necessarily have a layer structure formed of a plurality of layered magnetic films. For example, the upper cover layer 18 may be a molded object formed by molding a magnetic material, instead of a laminate in which the magnetic films 18a to 18d are layered.

As illustrated in FIG. 3, the coil conductor 25 includes a circumferential section 25a that is wound about the coil axis Ax1 which extends in the thickness direction (T-axis direction), a drawing section 25b1 that extends from one end of the circumferential section 25a to the first end surface 10c of the base body 10, and a drawing section 25b2 that extends from the other end of the circumferential section 25a to the second end surface 10d of the base body 10. The conductor patterns C11 to C17 and the vias V1 to V6 constitute the circumferential section 25a which has a spiral shape. That is, the circumferential section 25a includes the conductor patterns C11 to C17 and the vias V1 to V6.

Next, the fine structure of the base body 10 will be explained with reference to FIG. 4. FIG. 4 is a schematically enlarged cross-sectional view of a part of the cross section illustrated in FIG. 3. In FIG. 4, two of the plenty of soft magnetic metal particles contained in the base body 10 are schematically, partially illustrated.

As illustrated in FIG. 4, the soft magnetic metal particles contained in the base body 10 include a first soft magnetic metal particle 30a and a second soft magnetic metal particle 30b. The first soft magnetic metal particle 30a is adjacent to the second soft magnetic metal particle 30b. In FIG. 4, a cross section of the first soft magnetic metal particle 30a and a cross section of the second soft magnetic metal particle 30b each have a circular shape, for convenience. The soft magnetic metal particles contained in the base body 10 can have a variety of cross-section shape other than a circular shape. The soft magnetic metal particles contained in the base body 10 are composed of mainly Fe. The first soft magnetic metal particle 30a and the second soft magnetic metal particle 30b are examples of the soft magnetic metal particles contained in the base body 10. The explanation regarding the first soft magnetic metal particle 30a and the second soft magnetic metal particle 30b also applies to the remaining soft magnetic metal particles contained in the base body 10, other than the first soft magnetic metal particle 30a and the second soft magnetic metal particle 30b.

It is desirable that the content ratio of Fe in the soft magnetic metal particles contained in the base body 10 be 95 wt % or higher in order to give a high magnetic saturation characteristic to the base body 10. The content ratio of Fe in a soft magnetic metal particle contained in the base body 10 is measured by cutting the base body 10 along the coil axis Ax1, exposing a cross section of the base body 10, and conducting an energy dispersive X-ray spectroscopy (EDS) analysis on the cross section. The content ratio of Fe can be measured with an SEM equipped with an EDS detector. The EDS analysis using an SEM equipped with an EDS detector is called an SEM-EDS analysis. For example, the content ratio of Fe is measured with the scanning electron microscope SU7000 manufactured by Hitachi High-Tech Corporation and the energy dispersive X-ray spectroscopy detector Octane Elite manufactured by AMETEK, Inc. with an accelerating voltage of 5 kV. The content ratio of elements other than Fe in the first soft magnetic metal particle 30a is also measured by an SEM-EDS analysis similarly to the case of the content ratio of Fe.

A surface of each soft magnetic metal particle contained in the base body 10 is coated with an insulation film. Therefore, the soft magnetic metal particles contained in the base body 10 are electrically insulated from each other. For example, the surface of the soft magnetic metal particle 30a is coated with a first insulation film 40a, and the surface of the second soft magnetic metal particle 30b is coated with a second insulation film 40b. It is desirable that the surface of the first soft magnetic metal particle 30a be entirely coated with the first insulation film 40a and that the surface of the second soft magnetic metal particle 30b be entirely coated with the second insulation film 40b. In the base body 10, the soft magnetic metal particles are bonded to the adjacent soft magnetic metal particles via the insulation films disposed on the respective surfaces of the soft magnetic metal particles.

That is, the insulation films disposed on the respective surfaces of the adjacent soft magnetic metal particles are bonded to each other. Owing to the insulation films bonded to each other, the soft magnetic metal particles coated with the insulation films are bonded to each other. For example, the first soft magnetic metal particle 30a is bonded to the second soft magnetic metal particle 30b which is adjacent to the first soft magnetic metal particle 30a via the first insulation film 40a disposed on the surface of the first soft magnetic metal particle 30a and the second insulation film 40b disposed on the surface of the second soft magnetic metal particle 30b.

The soft magnetic metal particles contained in the base body 10 are obtained by heating precursor powder made from a soft magnetic material, for example. The base body 10 can be produced by preparing mixture powder of soft magnetic metal powder of a soft magnetic material and fine amorphous alumina powder and then heating a mixture resin composition of the mixture powder and resin. The detailed explanation of the production process will be given later. As a result of the heating treatment in the production process of the base body 10, the elements contained in the precursor powder are diffused on the surface of the precursor powder, and are oxidized on the surface of the precursor powder. Consequently, an insulation film containing an amorphous Al oxide which is derived from the amorphous alumina and the oxides of the elements contained in the precursor powder is formed on the surface of a soft magnetic metal particle.

The precursor powder of the soft magnetic metal particles contained in the base body 10 is composed of mainly Fe. Besides Fe, an additive element can be contained in the precursor powder of the soft magnetic metal particles contained in the base body 10. For example, besides Fe, an element A is contained as an additive element in the precursor powder of a soft magnetic metal particle contained in the base body 10.

The element A is more susceptible to oxidation than Fe. The element A is selected from the group consisting of Si, Ti, Al, Cr, Zr, and Mn. The element A is oxidized before Fe in the heating treatment of the precursor powder in an atmosphere in which oxygen exists. Accordingly, oxidation of Fe in the heating treatment can be suppressed. The precursor powder of the soft magnetic metal particles can slightly contain an element other than Fe and the element A. Examples of the element which can be slightly contained in the precursor powder of the soft magnetic metal particles include vanadium (V), zinc (Zn), boron (B), carbon (C), and nickel (Ni).

The insulation films which are disposed on the surfaces of the soft magnetic metal particles contained in the base body 10 each contain an oxide of an element contained in the precursor powder. The “insulation films which are disposed on the surfaces of the soft magnetic metal particles contained in the base body 10” include the first insulation film 40a which is disposed on the surface of the first soft magnetic metal particle 30a and the second insulation film 40b which is disposed on the surface of the second soft magnetic metal particle 30b. For convenience of explanation, the insulation films disposed on the surfaces of the soft magnetic metal particles contained in the base body 10 are simply referred to as “insulation films” in some cases.

In one embodiment, the thickness of each insulation film is equal to the distance between the adjacent soft magnetic metal particles. A cross section of the base body 10 may be observed at a predetermined magnification (e.g., ×10,000), and the average distance between, among the adjacent soft magnetic metal particles, the soft magnetic metal particles included in the observation visual field may be adopted as the thickness of each insulation film disposed on the surfaces of the soft magnetic metal particles. For example, the thickness of each insulation film is 5 to 20 nm. It is not necessary to make the thickness of each insulation film uniform in a circumferential direction of the soft magnetic metal particle. In other words, the thickness of each insulation film may vary at different points in the circumferential direction of the soft magnetic metal particle. In a case where the thickness of each insulation film varies at different points in the circumferential direction of the soft magnetic metal particle, the average of the thicknesses at the different points can be regarded as the thickness of the insulation film. The minimum thickness of the insulation film may be less than 5 nm. The maximum thickness of the insulation film may be greater than 20 nm. In a case where the thickness of each insulation film varies at different points in the circumferential direction of the soft magnetic metal particle, the maximum thickness thereof is less than ten times the minimum thickness.

An explanation will be further given of the insulation films covering the surfaces of the soft magnetic metal particles, with reference to FIG. 4. As illustrated in FIG. 4, the first insulation film 40a includes a first oxide region 41 that is composed of mainly an amorphous Al oxide and that covers a first surface region 31a which is a portion of the surface of the first soft magnetic metal particle 30a, a second oxide region 42a that is composed of mainly an oxide of the element A and that covers a second surface region 32a which is a portion of the surface of the first soft magnetic metal particle 30a, and a third oxide region 43a that is composed of mainly an Si oxide and that covers a third surface region 33a which is a portion of the surface of the first soft magnetic metal particle 30a. According to the illustrated embodiment, the first surface region 31a of the first oxide region 41 is in contact with the first soft magnetic metal particle 30a. However, the first oxide region 31a may be disposed, in the first insulation film 40a, spaced from the first soft magnetic metal particle 30a. A portion of the first oxide region 41 may be disposed in the first insulation film 40a, and the remaining portion may extend to the outside of the first insulation film 40a. The first oxide region 41 in FIG. 4 is an example of an oxide region that is composed of mainly an amorphous Al oxide contained in the base body 10. In addition to the first oxide region 41, the base body 10 can include a plurality of oxide regions that are composed of mainly an amorphous Al oxide. In the base body 10, an oxide region that is composed of mainly an amorphous Al oxide is disposed between, among the plurality of the soft magnetic metal particles, the adjacent soft magnetic metal particles. The first oxide region 41 is an example of such an oxide region that is composed of mainly an amorphous Al oxide in the base body 10, and thus, the explanation of the first oxide region 41 given herein also applies to the remaining oxide regions that are composed of mainly an amorphous Al oxide in the base body 10, other than the first oxide region 41.

On the surface of the first soft magnetic metal particle 30a, the proportion of the third oxide region 43a is less than that of the remaining regions other than the third oxide region 43a. That is, the proportion of the third oxide region is less than 50%. Therefore, the amount of an oxide covering the first soft magnetic metal particle 30a can be suppressed. In addition, on the surface of the first soft magnetic metal particle 30a, the proportion of the second oxide region 42a is less than that of the first oxide region 41. Therefore, the amount of an oxide covering the first soft magnetic metal particle 30a also can be suppressed.

In a case where the element A is Al, an Al oxide contained in the second oxide region 42a may be crystalline. A procedure for confirming whether the first oxide region 41 is composed of mainly an amorphous Al oxide and the second oxide region 42a is composed of mainly a crystalline Al oxide is as follows. First, a cross section of the base body 10 is observed with a scanning transmission electron microscope (STEM) equipped with an EDS detector. A contrast variation in an electron microscopy image is obtained through this observation, and an insulation film is identified in the observation field. Next, the composition of a region identified as the insulation film in the observation field is calculated with the EDS by a ZAF method. In this EDS analysis, of regions each including both an oxygen element and an Al element, a region in which the amount of Al elements (the atomic ratio (at %) of Al elements) is the largest of the amounts of the respective elements excluding the oxygen is determined as a region that is composed of mainly an Al oxide. Next, a reciprocal space image is obtained by performing Fourier transformation on the electron microscopy image of the observation region. If no cyclic contrast appear in the region that is composed of mainly an Al oxide on the reciprocal space image, the Al oxide in this region is determined to be amorphous. On the other hand, if a cyclic contrast appears in the region that is composed of mainly an Al oxide on the reciprocal space image, the Al oxide in this region is determined to be crystalline. Of the regions that are composed of mainly an Al oxide, a region where no cyclic contrast appear on the reciprocal space image corresponds to the first oxide region 41. Of the regions that are composed of mainly an Al oxide, a region where a cyclic contrast appears on the reciprocal space image corresponds to the second oxide region 42a.

If the element A is Al, the second oxide region 42a may be composed of mainly an Al oxide. The content of Al elements in the second oxide region 42a may be 75 at % or higher with respect to all the components excluding oxygen. The content of Al elements in the first oxide region 41 may be 75 at % or less with respect to all the components excluding oxygen.

In addition to the Al oxide, the first oxide region 41 may contain at least one amorphous oxide selected from the group consisting of an amorphous Si oxide, an amorphous Ca oxide, and an amorphous Mg oxide. The Si oxide contained in the first oxide region 41 may be amorphous silica. If the first oxide region 41 contains amorphous silica, an insulation property of the first oxide region 41 can be further improved.

In one embodiment, the first oxide region 41 is derived from the fine amorphous alumina particles which are mixed with the precursor powder of the soft magnetic metal particles in the production process of the base body 10. The fine amorphous alumina particles to be mixed with the precursor powder may each have a flat shape having a high aspect ratio. If the particle diameters of the fine amorphous alumina particles to be mixed with the precursor powder of the soft magnetic metal particles are smaller than the particle diameter of the precursor powder, the fine amorphous alumina particles easily adhere to the surface of the precursor powder. The fine amorphous alumina particle having adhered to the surface of the precursor powder forms the first oxide region 41 which covers a portion of the surface of a soft magnetic metal particle in the base body 10. If the particle diameters of the fine amorphous alumina particles are substantially equal to or larger than the particle diameter of the precursor powder of the soft magnetic metal particles, the amorphous alumina is likely to be present apart from the precursor powder in the mixed resin composition. The first oxide region 41 that is formed of the amorphous alumina is likely to be located apart from the first soft magnetic metal particle 30a in the base body 10.

In another embodiment, the precursor powder of the soft magnetic metal particles is produced by a publicly known method (e.g., atomization) in the presence of fine amorphous alumina particles. Accordingly, fine amorphous alumina particles that have relatively small particle diameters can be deposited on the surfaces of the precursor powder particles. Fine amorphous alumina particles that have relatively large particle diameters are present as isolated particles without being deposited on the surfaces of the precursor powder particles. The fine amorphous alumina particles are not deposited on all the precursor powder particles included in the precursor powder. That is, since the precursor powder is produced in the presence of fine amorphous alumina particles, the obtained precursor powder includes particles whose surfaces have the fine amorphous alumina particles deposited thereon, particles whose surfaces have no fine amorphous alumina particles deposited thereon, and fine amorphous alumina particles having relatively large particle diameters.

It is desirable that the Al oxide contained in the first oxide region 41 be alumina (Al₂O₃). In a case where the Al oxides contained in the first oxide region 41 and the second oxide region 42a are alumina, the first oxide region 41 and the second oxide region 42a have high insulation properties. In a case where there is a possibility that the first oxide region 41 and the second oxide region 42a contain aluminum oxides (e.g., aluminum oxides (II)) other than alumina, Raman spectroscopy may be conducted to determine that an Al oxide contained as the main component of each of the first oxide region 41 and the second oxide region 42a is alumina (aluminum oxide (III) instead of an aluminum oxide (II). In a case where the element A is Al, the explanation of the Al oxide contained in the first oxide region 41 given in this paragraph also applies to the Al oxide in the second oxide region 42a.

It is desirable that the Si oxide contained in the third oxide region 43a be silica (SiO₂). If an EDS analysis indicates that the presence amount of Si elements (the atomic ratio (at %) of Si elements) is the largest of the elements in the third oxide region 43a excluding oxygen, the third oxide region 43a is considered to be composed of mainly silica. Since the third oxide region 43a is composed of mainly silica having an insulation property, the third oxide region 43a has a high insulation property. In a case where there is a possibility that the third oxide region 43a contains a silicon oxide (e.g., silicon monoxide) other than silica, Raman spectroscopy may be conducted to determine that an oxide contained as the main component of the third oxide region 43a is silica (silicon dioxide) instead of a silicon monoxide.

Each insulation film may contain a nitride of an element contained in the precursor powder, in addition to an oxide of the element. In each insulation film, the ratio of the oxide (in terms of mass) is higher than the ratio of the nitride. Examples of the nitride contained in each insulation film can include an aluminum nitride and a silicon nitride. If the insulation film contains a nitride of an element contained in the precursor powder, excessive oxidization of the element contained in the precursor powder is suppressed. In general, an oxide exhibits higher hardness than a nitride. Since the amount of an oxide contained in the insulation film is larger than the mount of a nitride in the insulation film, the mechanical strength of the base body 10 is increased.

The surface of the first soft magnetic metal particle 30a is sectioned into the first surface region 31a, the second surface region 32a, and the third surface region 33a. In the embodiment illustrated in FIG. 4, the first surface region 31a of the surface of the first soft magnetic metal particle 30a is coated with the first oxide region 41, the second surface region 32a is coated with the second oxide region 42a, and the third surface region 33a is coated with the third oxide region 43a. Thus, the whole surface of the first soft magnetic metal particle 30a is coated with the second oxide region 42a and the third oxide region 43a having insulating properties. In a case where the first oxide region 41 is disposed in such a way as not to be in contact with the first soft magnetic metal particle 30a, the second surface region 32a and the third surface region 33a are defined while a region corresponding to the first surface region 31a does not exist on the surface of the first soft magnetic metal particle 30a.

The second oxide region 42a may be disposed in such a way as to cover at least a portion of the surface outside the first oxide region 41 as well as the second surface region 32a of the first soft magnetic metal particle 30a. In a case where the second oxide region 42a covers at least a portion of the surface outside the surface outside the first oxide region 41, even when a defect occurs in a portion of the first oxide region 41, the defective portion is covered with the second oxide region 42a. Accordingly, occurrence of an insulation breakdown starting from the defect in the first oxide region 41 can be inhibited. In addition, the second oxide region 42a may be formed in such a way as to cover at least a portion of the surface outside the third oxide region 43a. In a case where the surface outside the third oxide region 43a is covered with the second oxide region 42a, even when a defect occurs in a portion of the third oxide region 43a, the defective portion is covered with the second oxide region 42a. Accordingly, occurrence of an insulation breakdown starting from the defect in the third oxide region 43a can be inhibited. In the embodiment illustrated in FIG. 4, the surface outside the first oxide region 41 and the surface outside the third oxide region 43a are entirely covered with the second oxide region 42a. Since the surface outside the third oxide region 43a is entirely covered with the second oxide region 42a, an insulation breakdown can be inhibited more reliably.

The second oxide region 42a may be disposed in such

a way as to cover only on a portion of the surface outside the third oxide region 43a. In this case, the amount of the second oxide region 42a on the surface of the first soft magnetic metal particle 30a can be reduced. Accordingly, the filling rate of the soft magnetic metal particles in the base body 10 is improved in the embodiment in which only a portion of the surface outside the third oxide region 43a is covered with the second oxide region 42a, compared to an embodiment in which the surface outside the third oxide region 43a is entirely covered with the second oxide region 42a.

In the embodiment illustrated in FIG. 4, in the first insulation film 40a, there are a plurality of the third oxide regions 43a that are composed of mainly an Si oxide. The third oxide regions 43a are spaced from each other. That is, an Si oxide is not formed to have a layer shape to cover the whole surface of the first soft magnetic metal particle 30a, but is split into the third oxide regions 43a on the surface of the first soft magnetic metal particle 30a. For example, the amount of Si in the precursor powder is set to be very small such that a plurality of the third oxide regions 43a are formed discretely on the surface of the first soft magnetic metal particle 30a. In order to form the discrete third oxide regions 43a on the surface of the first soft magnetic metal particle 30a, the content ratio of Si in the precursor powder is 3 wt % or less, for example. The content ratio of Si in the precursor powder can be set to 1 to 3 wt %. In addition, the content ratio of the element A in the precursor powder can be set to be less than the content ratio of Si. For example, the content ratio of the element A in the precursor powder is set to 0.2 to 1 wt %.

The second insulation film 40b is disposed on the surface of the second soft magnetic metal particle 30b which is adjacent to the first soft magnetic metal particle 30a. The second insulation film 40b includes a second oxide region 42b that covers a second surface region 32b which is a portion of the surface of the second soft magnetic metal particle 30b and that is composed of mainly a crystalline Al oxide, and a third oxide region 43b that covers a third surface region 33b which is a portion of the surface of the second soft magnetic metal particle 30b and that is composed of mainly an Si oxide. In the illustrated embodiment, the second insulation film 40b does not include an oxide region (region corresponding to the first oxide region 41 in the first insulation film 40a) that is composed of mainly an amorphous Al oxide. In another embodiment, the second insulation film 40b may include an oxide region that is composed of mainly an amorphous Al oxide. In a case where the second insulation film 40b includes an oxide region that is composed of mainly an amorphous Al oxide, the explanation regarding the first oxide region 41 also applies to the oxide region in the second insulation film 40b composed of mainly an amorphous Al oxide. Like the second oxide region 42a, the second oxide region 42b is composed of mainly an oxide of the element A. The above explanation regarding the second oxide region 42a also applies to the second oxide region 42b. Like the third oxide region 43a, the third oxide region 43b is composed of mainly an Si oxide. The above explanation regarding the third oxide region 43a also applies to the third oxide region 43b.

In FIG. 4, a dotted line indicates the boundary between the first insulation film 40a and the second insulation film 40b. However, when a cross section of the base body 10 is observed, the boundary between the first insulation film 40a and the second insulation film 40b is not clearly visible in some cases. An oxide region (for example, an oxide region that is composed of mainly an Al oxide, an oxide region that is composed of mainly an Si oxide) that is located between the first soft magnetic metal particle 30a and the second soft magnetic metal particle 30b may be included in the first insulation film 40a, or may be included in the second insulation film 40b.

FIG. 4 indicates a geometric center Ca of the first soft magnetic metal particle 30a, a geometric center Cb of the second soft magnetic metal particle 30b, and a virtual straight line L1 passing through the geometric centers Ca and Cb. In addition, a reference line RL that perpendicularly intersects the virtual straight line L1 passing through the geometric centers Ca and Cb and that is located at equal distance from the surface of the first soft magnetic metal particle 30a and the surface of the second soft magnetic metal particle 30b is indicated in FIG. 4. The distance between the first soft magnetic metal particle 30a and the reference line RL refers to the shortest distance of a perpendicular line extending from a given point on the surface of the first soft magnetic metal particle 30a to the reference line RL. Similarly, the distance between the second soft magnetic metal particle 30b and the reference line RL refers to the shortest distance of a perpendicular line extending from a given point on the surface of the second soft magnetic metal particle 30b to the reference line RL. The second insulation film 40b and the first insulation film 40a are formed asymmetrically about the reference line RL. For example, the first oxide region 41 is included in the first insulation film 40a while any oxide region that is composed of mainly an amorphous Al oxide is not included in the second insulation film 40b. In addition, the third oxide region 43b included in the second insulation film 40b and the third oxide region 43a included in the first insulation film 40a are arranged asymmetrically about the reference line RL. In the embodiment illustrated in FIG. 4, when the area between the surface of the first soft magnetic metal particle 30a and the surface of the second soft magnetic metal particle 30b is observed along the straight line L1, the first oxide region 41 and the second oxide region 42a are disposed on the surface of the first soft magnetic metal particle 30a while only the second oxide region 42b is disposed on the surface of the second soft magnetic metal particle 30b. In this manner, the asymmetry arrangement of the first insulation film 40a and the second insulation film 40b about the reference line RL may be confirmed when the first insulation film 40a and the second insulation film 40b are observed along the straight line L1.

The first oxide region 41 is disposed between the first soft magnetic metal particle 30a and the second soft magnetic metal particle 30b. Since the first oxide region 41 is disposed between the first soft magnetic metal particle 30a and the second soft magnetic metal particle 30b, the bonding strength between the first soft magnetic metal particle 30a and the second soft magnetic metal particle 30b is increased. Unlike an oxide layer in related art, the first oxide region 41 is locally disposed between the first soft magnetic metal particle 30a and the second soft magnetic metal particle 30b in a circumferential direction of the first soft magnetic metal particle 30a, without surrounding the first soft magnetic metal particle 30a (that is, the first oxide region 41 is not one of oxide layers constituting the layered structure surrounding the first soft magnetic metal particle 30a). In an existing technology, to increase the bonding strength of soft magnetic metal particles by increasing the thickness of an insulation film, a production step has been devised to increase a heating time period of precursor powder, for example, so that the film thickness of an oxide layer surrounding each soft magnetic metal particle is made uniformly thick in the circumferential direction. In contrast, the first oxide region 41 is locally disposed in the area between the first soft magnetic metal particle 30a and the second soft magnetic metal particle 30b. Accordingly, the filling rate of the first oxide region 41 on the soft magnetic metal particle is reduced with an increase of the thickness of the insulation film connecting the first soft magnetic metal particle 30a and the second soft magnetic metal particle 30b (the total thickness of the first insulation film 40a and the second insulation film 40b). Therefore, the increase of the amount of the insulation film when the first oxide region 41 is provided is smaller than the increase of the amount of an insulation film when the insulation film is made uniformly thick in the circumferential direction to increase a bonding strength as in a magnetic base body in the related art. Consequently, the reduction in the filling rate of the soft magnetic metal particles when the first oxide region 41 is provided can be suppressed, compared to the reduction in the filling rate when the film thickness of an insulation film is uniformly thick as in a magnetic base body in the related art. Accordingly, in the base body 10, the bonding strength between the soft magnetic metal particles can be improved while reduction in the filling rate of the soft magnetic metal particles is suppressed. In other words, compared to a magnetic base body in the related art, the bonding strength between the soft magnetic metal particles in the base body 10 can be improved while the filling rate of the soft magnetic metal particles is highly maintained.

It is desirable that the first oxide region 41 be disposed in a region, on the surface of the first soft magnetic metal particle 30a, where the first soft magnetic metal particle 30a faces the second soft magnetic metal particle 30b. If the first oxide region 41 is disposed in the region where the first soft magnetic metal particle 30a faces the second soft magnetic metal particle 30b, strong bonding between the first soft magnetic metal particle 30a and the second soft magnetic metal particle 30b can be ensured.

The first oxide region 41 which is composed of mainly an amorphous Al oxide has a high insulation property. For this reason, if the first oxide region 41 is disposed in the region, on the surface of the first soft magnetic metal particle 30a, where the first soft magnetic metal particle 30a faces the second soft magnetic metal particle 30b, the insulation performance between the first soft magnetic metal particle 30a and the second soft magnetic metal particle 30b can be improved.

FIG. 4 indicates two virtual lines TL1 and TL2 passing through the geometric center Ca of the first soft magnetic metal particle 30a and being connected to the outer surface of the second soft magnetic metal particle 30b. In the embodiment illustrated in FIG. 4, in a cross section taken along a plane passing through the first soft magnetic metal particle 30a and the second soft magnetic metal particle 30b, the first oxide region 41 extends along the surface of the first soft magnetic metal particle 30a over the region between the virtual lines TL1 and T12. Since the first oxide region 41 extends along the surface of the first soft magnetic metal particle 30a over the region between the virtual lines TL1 and TL2, the strong bonding between the first soft magnetic metal particle 30a and the second soft magnetic metal particle 30b can be ensured while reduction in the filling rate of the soft magnetic metal particles in the base body 10 is suppressed. In addition, the insulation performance between the first soft magnetic metal particle 30a and the second soft magnetic metal particle 30b can be improved.

In one embodiment, in an electron microscope image obtained by imaging, with a predetermined magnification, a cross section of the base body 10 taken along a plane passing through the first soft magnetic metal particle 30a and the second soft magnetic metal particle 30b, the area of the first oxide region 41 occupies 2% or less of the total area of the observation field. This electron microscope image is obtained by imaging the cross section of the base body 10 with a magnification of ×10,000, for example. Since the percentage of the first oxide region 41 in the cross section of the base body 10 is 2% or less, reduction of the filing rate of the soft magnetic metal particles, which may be caused by the first oxide region 41, can be suppressed.

Since the soft magnetic metal particles in the base body 10 are each covered with the insulation film containing oxides of two kinds of elements (i.e., the element A and Si), the base body 10 has an excellent insulation property. In one embodiment, the soft magnetic metal particles are each covered with the insulation film containing oxides of two kinds of elements, the voltage resistance of the base body 10 can be increased. In order to obtain high voltage resistance by forming an insulation film of one kind of an oxide, the surface of each soft magnetic metal particle needs to be entirely covered with a layer of the oxide. However, if a molded object of the precursor powder is prepared in the production process of the base body 10 in such a way as to prevent reduction of the filling rate of the precursor powder, an element that is oxidized during heating of the molded object is not sufficiently diffused. A thin layer of an oxide of the element may be formed on a part of the surface of each soft magnetic metal particle. This thin layer of the oxide is likely to be produced between the soft magnetic metal particles. Depending on the filling rate in the molded object or the heating condition, the surface of each soft magnetic metal particle is not entirely covered with the insulation film, and adjacent soft magnetic metal particles come into direct contact with each other, whereby the voltage resistance of the magnetic base body may be deteriorated. In the base body 10 of the present application, the insulation film contains oxides of two kinds of elements even if the filling rate of the precursor powder in the molded object is high. Thus, the surface of each soft magnetic metal particle is covered with the insulation film that contains oxides of two kinds of elements. Accordingly, if the surface of a soft magnetic metal particle includes a region that is not covered with an oxide of one of the elements, this region is covered with an oxide of the other element.

Specifically, in the base body 10, the second oxide region 42a is formed on only a part of the first soft magnetic metal particle 30a (i.e., the second surface region 32a) while the remaining region (i.e., the first surface region 31a) on the surface of the first soft magnetic metal particle 30a is covered with the first oxide region 41 that is composed of mainly an oxide of the element A. Accordingly, deterioration of the voltage resistance, which may be caused when the surface of the first soft magnetic metal particle 30a is partially exposed, can be suppressed. The soft magnetic metal particles in the base body 10 other than the first soft magnetic metal particle 30a are also covered with the insulation films that each contain oxides of the two elements (i.e., the element A and Si). Therefore, the voltage resistance of the base body 10 is increased.

The difference between an insulation film (e.g., the first insulation film 40a) disposed on the surface of each soft magnetic metal particle contained in the base body 10 of the present application and a related-art insulation film disposed on the surface of each soft magnetic metal particle will be explained. In a case where an insulation film covering the surface of each soft magnetic metal particle contains oxides of two or more kinds of elements, the insulation film in the related art has a layered structure in which the oxides of the elements are each formed into a layer shape and the layer-shaped oxide layers are layered. That is, the insulation film of the related-art magnetic base body has a first oxide layer which is composed of mainly an oxide of a first element and which covers the entire outer surface of an soft magnetic metal particle, and a second oxide layer which is composed of mainly an oxide of a second element and which covers the entire outer surface of the first oxide layer. Such a related-art magnetic base body which has an insulation film having a layered structure is disclosed in Japanese Patent Laid-Open No. 2021-158261, for example.

In contrast, in the base body 10 of the present application, the second surface region 32a on the surface of the first soft magnetic metal particle 30a is covered with the second oxide region 42a, and the third surface region 33a of the first soft magnetic metal particle 30a is covered with the second oxide region. For this reasons, in the base body 10 to which the present technology is applied, the ratio of the insulation film in the base body 10 can be reduced, compared to the related-art magnetic base body having an insulation film formed by layering two or more oxide layers. As a result, the filling rate of the soft magnetic metal particles in the base body 10 is increased. Accordingly, a magnetic characteristic of the base body 10 can be improved, compared to the related-art magnetic base body having an insulation film formed by layering two or more oxide layers. In addition, since the first oxide region 41 is locally disposed between the first soft magnetic metal particle 30a and the second soft magnetic metal particle 30b in the circumferential direction of the first soft magnetic metal particle 30a, reduction of the filling rate of the soft magnetic metal particles, which may be caused by the first oxide region 41, is suppressed, compared to reduction of the filling rate caused when the film thickness of an oxide layer is made uniformly thick in the circumferential direction in the related-art magnetic base body.

An oxide contained in the insulation film covering the surface of each soft magnetic metal particle contained in the base body 10 may be derived from an element contained in the precursor powder of the soft magnetic metal particles, as previously explained. In another embodiment, an oxide contained in the insulation film is not necessarily derived from the precursor powder of the soft magnetic metal particles. For example, the first oxide region 41 may be derived from fine amorphous alumina particles mixed with the precursor powder, as previously explained. In addition, the second oxide region 42a may be derived from fine crystalline alumina particles mixed with the precursor powder. Further, the Si oxide contained in the third oxide region 43a is also not necessarily derived from the precursor powder of the soft magnetic metal particles. For example, an Si oxide (silica) is formed on the surface of the precursor powder (soft magnetic metal particles) by impregnating the precursor powder with a mixture solution of TEOS, ethanol, and an ammonia solution, stirring the mixture solution, and drying the solution. The resultant Si oxide may be amorphous. Accordingly, an oxide of Si that is not derived from an Si element contained in the precursor powder can be deposited on the surface of the soft magnetic metal particle. The third oxide regions 43a and 43b may be formed of silica formed on the surfaces of the soft magnetic metal particles.

In a case where an oxide of the element A, the Al oxide, or the Si oxide contained in the insulation film covering the surface of a soft magnetic metal particle is not derived from the element A, Al, or Si contained in the precursor powder, the content ratio of the element A, Al, or Si in the precursor powder can be set to be smaller. In a case where the oxide of the element A contained in the insulation film (for example, the second oxide region 42a) is not derived from the element A contained in the precursor powder, the content ratio of the element A in the precursor powder can be set to 0.2 to 1 wt %. In a case where the Si oxide contained in the insulation film is not derived from Si contained in the precursor powder, the content ratio of Si in the precursor powder can be set to 1 to 3 wt %. If the content ratio of Al or Si in the precursor powder is reduced, the content ratio of Fe in the precursor powder is increased. As a result of this, the content ratio of Fe in the soft magnetic metal particles is also increased.

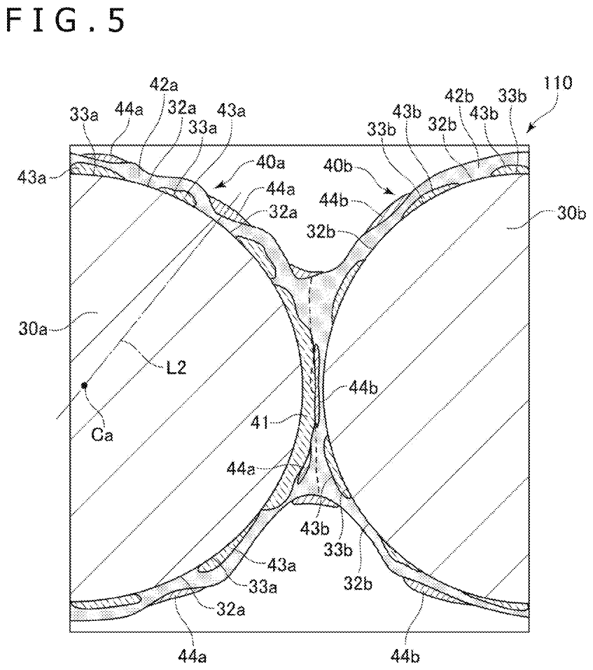

Next, another embodiment of a base body to which the present technology is applied will be explained with reference to FIG. 5. FIG. 5 is a schematically enlarged cross-sectional view of a part of a cross section of a base body 110 according to another embodiment. The base body 110 in FIG. 5 differs from the base body 10 in that an insulation film in the base body 110 includes a third oxide region that is composed of mainly an oxide of an element C. In the base body 110, as illustrated in FIG. 5, the first insulation film 40a covering the first soft magnetic metal particle 30a includes a fourth oxide region 44a in addition to the second oxide region 42a and the third oxide region 43a, and the second insulation film 40b covering the second soft magnetic metal particle 30b includes a fourth oxide region 44b in addition to the second oxide region 42b and the third oxide region 43b. The first insulation film 40a may include a plurality of the fourth oxide regions 44a that are spaced from each other. The second insulation film 40b may include a plurality of the fourth oxide regions 44b that are spaced from each other.

The fourth oxide region 44a is formed in a position spaced from the surface of the first soft magnetic metal particle 30a. In other words, the second oxide region 42a and/or the third oxide region 43a is disposed between the fourth oxide region 44a and the surface of the first soft magnetic metal particle 30a. In the illustrated embodiment, the fourth oxide region 44a is spaced also from the third oxide region 43a. In other words, the second oxide region 42a is disposed between the fourth oxide region 44a and the third oxide region 43a. Alternatively, the fourth oxide region 44a may be formed in such a way as to be in contact with the third oxide region 43a.

The fourth oxide region 44a is disposed outside the second oxide region 42a in a radial direction of the first soft magnetic metal particle 30a. In one embodiment, at least one of the plurality of fourth oxide regions 44a may be disposed in a position, in the circumferential direction of the first soft magnetic metal particle 30a, corresponding to the second surface region 32a. In other words, at least one of the plurality of fourth oxide regions 44a may be disposed outside the second surface region 32a in the radial direction. Not the third oxide region 43a but the second oxide region 42a is disposed in a region corresponding to the second surface region 32a in the circumferential direction of the first soft magnetic metal particle 30a. On the other hand, the third oxide region 43a is disposed in a region corresponding to the third surface region 33a in the circumferential direction of the first soft magnetic metal particle 30a, and the second oxide region 42a is disposed radially outside the third oxide region 43a. Accordingly, the second oxide region 42a is inwardly recessed in a position corresponding to the second surface region 32a in the circumferential direction of the first soft magnetic metal particle 30a. In one embodiment, the fourth oxide region 44a is disposed in the recess of the second oxide region 42a located in the position corresponding to the second surface region 32a in the circumferential direction of the first soft magnetic metal particle 30a. Since the fourth oxide region 44a is disposed in the recess in the second oxide region 42a, the film thickness of the first insulation film 40a is uniform in the circumferential direction. If a portion of the first insulation film 40a is thinner than the remaining portion, there is a possibility that an insulation breakdown occur in the thin portion of the first insulation film 40a. If the film thickness of the first insulation film 40a is uniform in the circumferential direction, occurrence of an insulation breakdown in the thin portion of the first insulation film 40a can be prevented. In a case where the fourth oxide region 44a is radially outside the second surface region 32a, a straight line connecting the geometric center Ca of the first soft magnetic metal particle 30a to the fourth oxide region 44a disposed radially outside the second surface region 32a passes through the second oxide region 42a but does not pass through the third oxide region 43a.

Like the fourth oxide region 44a, the fourth oxide region 44b is formed in a position spaced from the surface of the second soft magnetic metal particle 30b. In addition, the fourth oxide region 44b may be spaced from the third oxide region 43b. The fourth oxide region 44b may be formed in such a way as to be in contact with the third oxide region 43b. Moreover, the fourth oxide region 44b may be disposed in a recess in the second oxide region 42b located in a position corresponding to the second surface region 32b in a circumferential direction of the second soft magnetic metal particle 30b.

The fourth oxide regions 44a to 44c each contain an Fe oxide and a Cr oxide. In one embodiment, each of the fourth oxide regions 44a to 44c are composed of mainly chromite (FeCr₂O₄). In a case where an Fe oxide is formed in an insulation film covering an Fe-base soft magnetic metal particle, the Fe oxide may be hematite (Fe₂O₃) or magnetite (Fe₃O₄). When hematite which is non-magnetic and magnetite which is ferromagnetic concurrently exist between soft magnetic metal particles, local magnetic saturation is likely to occur in the region where magnetite exists. In a case where chromite which has no magnetic property is used as the main component of the fourth oxide region 44a which contains Fe, the uniformity of magnetic fluxes between the soft magnetic metal particles can be improved, whereby occurrence of a local magnetic saturation between soft magnetic metal particles can be suppressed. Accordingly, a magnetic saturation characteristic of the base body 110 is improved, compared to a magnetic base body in which the content of magnetite is large.

The fourth oxide regions 44a to 44c included in the insulation film each can contain chromite (FeCr₂O₄), hematite (Fe₂O₃), and magnetite (Fe₃O₄). In one embodiment, the content ratio of chromite with respect to the total amount of the oxides (the sum of chromite, hematite, and magnetite) may be 50% or higher in each of the fourth oxide regions 44a to 44c. If the content ratio of chromite which has no magnetic property is set to 50% or higher, the relative permeability of the insulation film becomes smaller, compared to a case where the content of a ferromagnetic oxide (e.g., magnetite) is large. Thus, a magnetic saturation characteristic of the base body 110 can be improved. In another embodiment, the sum of the content ratio of chromite and the content ratio of hematite with respect to the total amount of the oxides may be 80% or higher. If the total content ratio of chromite and hematite which have no magnetic property is set to 80% or higher, the relative permeability of the insulation film is smaller, compared to a case where the content of a ferromagnetic oxide (e.g., magnetite) is large. Thus, a magnetic saturation characteristic of the base body 110 can be improved.

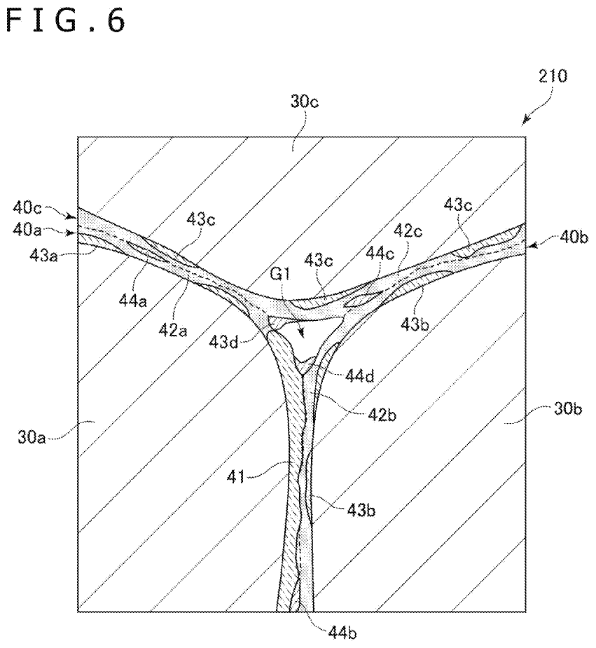

Next, still another embodiment of a base body to which the present technology is applied will be explained with reference to FIG. 6. FIG. 6 is a schematically enlarged cross-sectional view of a part of a cross section of a base body 210 according to another embodiment. In the cross section of the base body 210 in FIG. 6, a region around the boundary among three soft magnetic metal particles is enlarged. As illustrated in FIG. 6, the base body 210 includes the first soft magnetic metal particle 30a, the second soft magnetic metal particle 30b, and a third soft magnetic metal particle 30c. The first soft magnetic metal particle 30a, the second soft magnetic metal particle 30b, and the third soft magnetic metal particle 30c are adjacent to one other. As described above, the first soft magnetic metal particle 30a is covered with the first insulation film 40a, and the second soft magnetic metal particle 30b is covered the second insulation film 40b. Similarly, the third soft magnetic metal particle 30c is covered with a third insulation film 40c. The third insulation film 40c has a configuration similar to those of the first insulation film 40a and the second insulation film 40b. That is, the third insulation film 40c includes a second oxide region 42c that is composed of mainly an oxide of the element A and that covers a second surface region 32c which is a portion of the surface of the third soft magnetic metal particle 30c, a third oxide region 43c that is composed of mainly an oxide of an Si oxide and that covers a third surface region 33c which is a portion of the surface of the third soft magnetic metal particle 30c, and a fourth oxide region 44c that is composed of mainly an oxide of the element C and that is spaced from the surface of the third soft magnetic metal particle 30c. Like the fourth oxide regions 44a and 44b, the fourth oxide region 44c may be composed of mainly chromite.

A gap that is not filled with any insulation film exists among the soft magnetic metal particles in the base body 210. For example, a gap G1 exists among the first soft magnetic metal particle 30a, the second soft magnetic metal particle 30b, and the third soft magnetic metal particle 30c in the base body 210, as illustrated in FIG. 6. At least a portion of the gap G1 is defined by a fourth oxide region 44d which is composed of mainly a Cr oxide. In other words, the fourth oxide region 44d is disposed at a position facing the gap that exists among the soft magnetic metal particles. Like the fourth oxide regions 44a to 44c, the fourth oxide region 44d may be composed of mainly chromite. At least a portion of the gap G1 may be defined by the first oxide region 41, as illustrated in FIG. 6. In the illustrated embodiment, the gap G1 is defined by the first oxide region 41, the fourth oxide region 44d, and the second oxide regions 42a to 42c.

In the base body 210, the gap that exists among the soft magnetic metal particles is partially filled with the first oxide region 41 and the fourth oxide region 44d. Accordingly, the mechanical strength of the base body 210 can be improved, compared to a case where the first oxide region 41 and the fourth oxide region 44d are not provided.

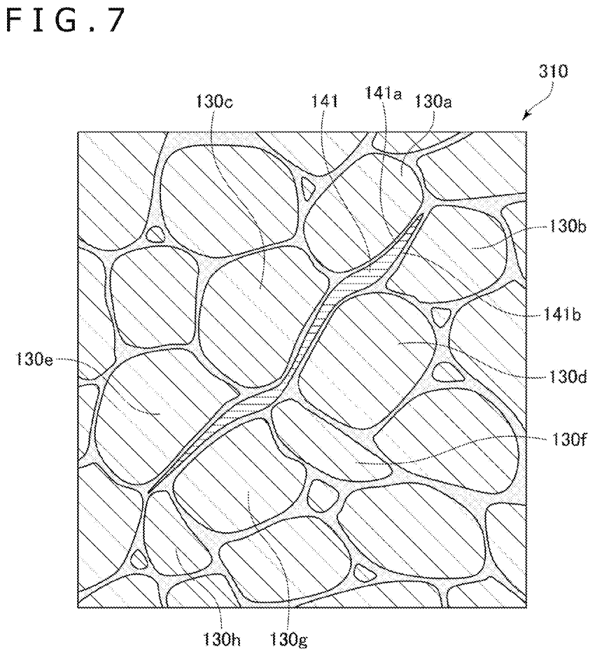

Next, yet another embodiment of a base body to which the present technology is applied will be explained with reference to FIG. 7. FIG. 7 is a schematically enlarged cross-sectional view of a part of a cross section of a base body 310 according to another embodiment. In FIG. 7, a cross section of the base body 310 is enlarged at a lower magnification than those in FIGS. 4 to 6. Thus, ten or more soft magnetic metal particles are depicted in FIG. 7. An insulation film is disposed on the surface of each soft magnetic metal particle contained in the base body 310. In FIG. 7, illustration of the insulation film is omitted for simplicity.

A plurality of soft magnetic metal particles contained in the base body 310 include soft magnetic metal particles 130a to 130h, as illustrated in FIG. 7. A first oxide region 141 is disposed in an area among the soft magnetic metal particles 130a to 130h. Like the first oxide region 41, the first oxide region 141 is composed of mainly an amorphous Al oxide. The first oxide region 141 is spaced from all the soft magnetic metal particles contained in the base body 310. A cross section of the first oxide region 141 has a high aspect ratio, as illustrated in FIG. 7. The first oxide region 141 includes a first surface 141a and a second surface 141b that faces the first surface 141a. The outer edge of the cross section is defined by the first surface 141a and the second surface 141b.

The first oxide region 141 is disposed in the base body 310 with the first surface 141a facing a plurality of soft magnetic metal particles and the second surface 141b facing a plurality of soft magnetic metal particles. In the embodiment illustrated in FIG. 7, the first surface 141a of the first oxide region 141 faces the soft magnetic metal particle 130a, the soft magnetic metal particle 130c, and the soft magnetic metal particle 130e while the second surface 141b faces the soft magnetic metal particle 130b, the soft magnetic metal particle 130d, the soft magnetic metal particle 130f, the soft magnetic metal particle 130g, and the soft magnetic metal particle 130h. Accordingly, the first oxide region 141 extends through an area between the soft magnetic metal particle 130a and the soft magnetic metal particle 130b, an area among the soft magnetic metal particle 130c, the soft magnetic metal particle 130d, and the soft magnetic metal particle 130f, and an area among the soft magnetic metal particle 130e, the soft magnetic metal particle 130g, and the soft magnetic metal particle 130h.

The base body 310 can be produced by preparing mixture powder of precursor powder of the soft magnetic metal particles and fine amorphous alumina particles, compressing a mixture resin composition of the mixture powder and resin to produce a molded object, and then heating the molded object. Each of the fine amorphous alumina particles which are mixed with the precursor powder of the soft magnetic metal particles may be processed into a flat shape having a high aspect ratio. The particle diameter of the fine amorphous alumina particles which are a raw material of the first oxide region 141 may be larger than the particle diameter of the fine amorphous alumina particles which are a raw material of the first oxide region 41. The fine amorphous alumina particles which have large particle diameters and have flat shapes are arranged not between a pair of particles of the precursor powder and but among a plurality of pairs of particles of the precursor powder in the molded object. The fine amorphous alumina particles are turned into the first oxide region 141 in the base body 310.

In the base body 310, the first oxide region 141 is disposed between the soft magnetic metal particle 130a and the soft magnetic metal particle 130b, among the soft magnetic metal particle 130c, the soft magnetic metal particle 130d, and the soft magnetic metal particle 130f, and among the soft magnetic metal particle 130e, the soft magnetic metal particle 130g, and the soft magnetic metal particle 130h. Thus, strong bonding of the soft magnetic metal particles can be ensured.

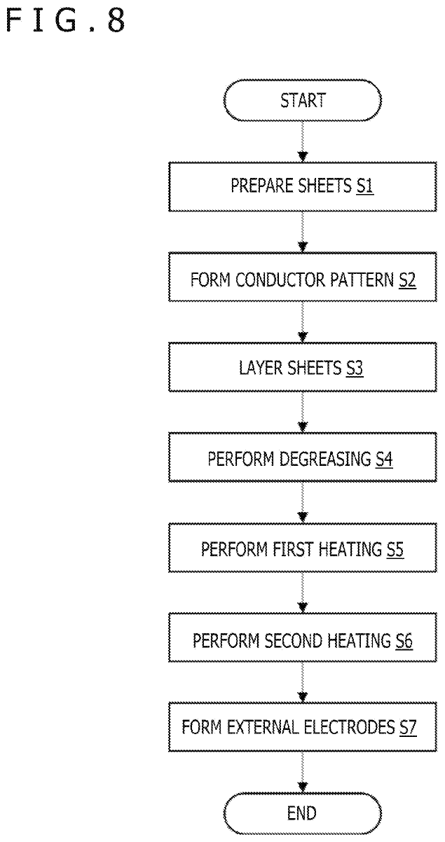

Next, one example of a method for producing the coil component 1 will be explained with reference to FIG. 8. A method for producing the base body 10, which is produced in the course of the producing process of the coil component 1, also will be explained with reference to FIG. 8. FIG. 8 is a flowchart depicting a method for producing the coil component 1 according to one embodiment of the present technology. The following explanation is based on the assumption that the coil component 1 is produced by a sheet lamination method. The coil component 1 may be produced by any other publicly known method. The coil component 1 can be produced by a lamination method such as a print laminating method, a thin film process method, or a slurry building method, for example.

First, in step S1, magnetic material sheets are prepared. The magnetic material sheets are made from a magnetic material paste that is obtained by preparing mixture powder of a mixture of fine amorphous alumina particles and soft magnetic metal powder (precursor powder) which is a raw material of the soft magnetic metal particles, and kneading the mixture powder with a binder resin and a solvent. The precursor powder is made from a soft magnetic metal material. The precursor powder contains Fe, the element A, and Si. The precursor powder can contain an additive element other than Fe and the element A. The following explanation of the production method is based on the assumption that the precursor powder contains Fe, Al, Si, and Cr, for easy understanding. The precursor powder contains at least 95 wt % of Fe. The total content ratio of the additive element other than Fe in the precursor powder is set to 5 wt % or lower. The precursor powder can contain 0.2 to 1 wt % of Al. The precursor powder can contain 1 to 3 wt % of Si. The precursor powder can contain 0.5 to 1.5 wt % of Cr. The content ratio of Si may be higher than the content ratio of Al in the precursor powder.

The binder resin for the magnetic material paste is an acrylic resin, for example. The binder resin for the magnetic material paste may be a polyvinyl butyral (PVB) resin, a phenol resin, any other publicly known binder resin, or a mixture thereof. The solvent is toluene, for example. The magnetic material paste is applied to a surface of a plastic base film by a doctor blade method or any other common method. The magnetic material paste on the surface of the base film is dried to obtain a sheet-shaped molded object. A molding pressure of approximately 10 to 100 MPa is applied to the sheet-shaped molded object inside a mold, and a plurality of the magnetic material sheets are thereby prepared.

Next, in step S2, a conductive paste is applied to a part of the magnetic material sheets prepared in step S1. The conductive paste is prepared by kneading conductive powder which is formed of an excellently conductive material such as Ag, Pd, Cu, Al, or an alloy thereof with a binder resin and a solvent. A resin of the same kind as the binder resin for the magnetic material paste may be used as the binder resin for the conductive paste. Acrylic resins may be used as the binder resin for the conductive paste and the binder resin for the magnetic material paste.

When the conductive paste is applied to the magnetic material sheets, unsintered conductor patterns which are to be turned into the conductor patterns C11 to C17 after sintering are formed on the magnetic material sheets. A through whole extending in a lamination direction is formed in a part of the magnetic material sheets. When the conductive paste is applied to the magnetic material sheets having the through holes, the conductive paste fills the through holes. As a result, unsintered vias which are turned into the vias V1 to V5 after sintering are formed in the through holes in the magnetic material sheets. The conductive paste is applied to the magnetic material sheets by screen printing, for example.

Next, in step S3, the magnetic material sheets prepared in step S1 are layered to form an upper laminate to be turned into the upper cover layer 18, an intermediate laminate to be turned into the main layer 20, and a lower laminate to be turned into the lower cover layer 19. Each of the upper laminate and the lower laminate is formed by layering four sheets, of the magnetic material sheets prepared in step S1, having no unsintered conductor pattern. The four magnetic material sheets of the upper laminate are turned into the magnetic films 18a to 18d in the coil component 1 which is a finished product. The four magnetic material sheets of the lower laminate are turned into the magnetic films 19a to 19d in the coil component 1 which is a finished product. The intermediate laminate is formed by layering seven sheets, of the magnetic material sheets, having respective unsintered conductor patterns in a predetermined order. The seven magnetic material sheets in the intermediate laminate are turned into the magnetic films 11 to 17 in the coil component 1 which is a finished product. The produced intermediate laminate is put between the upper laminate and the lower laminate, and thermocompression bonding of the upper laminate and the lower laminate to the intermediate laminate is performed to obtain the main laminate. Next, the main laminate is cut into pieces of a desired size with a cutting machine such as a dicing machine or a laser processor, whereby chip laminates are obtained. Each chip laminate is an example of the molded object including a raw element which is to be turned into the base body 10 after heating treatment and an unsintered conductor pattern which is to be turned into the coil conductor 25 after heating treatment. The molded object including the raw element which is to be turned into the base body 10 after heating treatment and the unsintered conductor patterns which is to be turned into the coil conductor 25 after heating treatment may be produced by a method other than the sheet lamination method.

In the molded object produced in step S3, the filling rate of the precursor powder is 85% or higher. The filling rate of the precursor powder in the molded object is achieved by adjusting the molding pressure for molding the magnetic material sheets according to the type of the binder resin, the particle diameter of the precursor powder, and any other parameter. A percentage that indicates the area ratio of the precursor powder with respect to the total area of the observation field of an SEM image of a cross section of the molded object can be used as the filling rate of the precursor powder in the molded object.

Next, in step S4, degreasing is performed on the molded object produced in step S3. In a case where thermally-decomposable resins are used as the binder resin for the magnetic material paste and the binder resin for the conductive paste, the degreasing can be performed on the molded object in a non-oxygen atmosphere such as a nitride atmosphere. If the degreasing is performed in the non-oxygen atmosphere, oxidation of Fe contained in the precursor powder can be prevented during the degreasing. The degreasing is performed at a temperature higher than the thermal decomposition start temperature of the binder resin for the magnetic material paste. In a case where an acrylic resin is used as the binder resin for the magnetic material paste, the degreasing is performed at, for example, 300° C. to 500° C. which is higher than the thermal decomposition start temperature of the acrylic resin. The thermally-decomposable resin in the molded object is decomposed through the degreasing. Therefore, after the degreasing is completed, the thermally-decomposable resin does not remain in the molded object. Since the thermally-decomposable resin which is the same as the binder resin of the magnetic material paste is used as the binder resin for the conductive paste, the thermally-decomposable resin contained in the unsintered conductor pattern is also thermally decomposed through the degreasing in step S4. In this manner, the magnetic material sheets constituting the molded object and the unsintered conductor patterns are both degreased.

Next, in step S5, first heating treatment is performed on the degreased molded object. The first heating treatment is performed at the first heating temperature of 500° C. to 800° C. in a low oxygen concentration atmosphere in which the oxygen concentration is 5 to 600 ppm. Since the precursor powder is heated at 500° C. to 800° C., Al and Si are thermally diffused to an area near the surface of precursor powder, and are combined with oxygen from the atmosphere. In a case where the precursor powder contains Cr, Cr is also diffused to the area near the surface of precursor powder. The first heating treatment produces oxides of Al and Si, which are susceptible to oxidation among additive elements having moved to the surface of the precursor powder. As a result of the first heating treatment, an oxide region that is composed of mainly an Al oxide (for example, the first oxide region 41) and an oxide region that is composed of mainly an Si oxide (for example, the third oxide region 43a) are formed on the surface of the heated precursor powder, as illustrated in FIGS. 4 to 6. The first heating time period of the first heating treatment can be set to fall within the range of one hour to six hours. For example, the first heating time period can be set to one hour. There is a possibility that Fe, which is less susceptible to oxidation than Al and Si, is slightly oxidized in the first heating treatment. The first heating treatment is performed in a low oxygen concentration atmosphere. Thus, if Fe is oxidized, oxides of Fe are produced such that an amount of produced magnetite (Fe₃O₄) is larger than an amount of produced hematite (Fe₂O₃). The first heating treatment produces an oxide of Fe radially outside the second oxide region 42a and the third oxide region 43a.

Next, in step S6, second heating treatment is performed on the molded object having undergone the first heating treatment, under an oxygen concentration that is higher than that in the first heating treatment. The second heating treatment may be performed in a low oxygen atmosphere in which the oxygen concentration is higher than 600 ppm but is equal to or lower than 3,000 ppm. Since the second heating treatment is performed at the concentration of oxygen higher than that in the first heating treatment, oxidation of Si and Al further proceeds. In a case where the precursor powder contains Cr, magnetite produced by the first heating treatment is combined with Cr during the second heating treatment. Accordingly, chromite (FeCr₂O₄) is produced. Excessive supply of oxygen to the surface of the precursor powder is inhibited because the filling rate of the precursor powder in the molded object is as high as at least 85%, as previously explained. Therefore, in a region, near the surface of the precursor powder, where magnetite and Cr elements exist, chromite (FeCr₂O₄) is more likely to be produced than hematite (Fe₂O₃) or a chromium oxide (III) by the second heating treatment.

Thus, in a case where the precursor powder contains Cr, an oxide region (for example, the fourth oxide region 44a) that is composed of mainly chromite is produced radially outside the second oxide region 42a or the third oxide region 43a by the second heating treatment. In a case where Cr is not contained in the precursor powder, chromite is not produced.

During the second heating treatment, not only oxidization of the precursor powder but also sintering of the conductor powder in the unsintered conductor patterns occurs. As a result of the sintering of the conductor powder in the unsintered conductor patterns, the coil conductor 25 is obtained. In a case where copper powder is used as the conductor powder, copper crystals are closely sintered to form the coil conductor 25.

The second heat treatment is performed at a second heating temperature for a second heating time period. The second heating temperature and the second heating time period are determined to form an insulation film having such a sufficient film thickness that the surface of the precursor powder has an insulation property. The second heating temperature can set to 500° C. to 800° C., for example. When the second heating temperature is increased, the progressive speed of the oxidization becomes higher. Therefore, the second heating time period changes depending on the second heating temperature. If the second heating temperature is 500° C., the second heating time period can fall within the range of one hour to six hours. If the second heating temperature is 800° C., the second heating time period can fall within the range of 30 minutes to one hour.

Thus, since the precursor powder contained in the molded object is oxidized by the first heating treatment and the second heating treatment, the soft magnetic metal particles whose surfaces are covered with the insulation films are produced from the precursor powder. In a case where Cr is not contained in the precursor powder, the first soft magnetic metal particle 30a covered with the first insulation film 40a and the second soft magnetic metal particle 30b covered with the second insulation film 40b are produced, as illustrated in FIG. 4, for example. In a case where the precursor powder contains Cr, the first insulation film 40a that includes the fourth oxide region 44a which is composed of mainly chromite is produced, and further, the second insulation film 40b that includes the fourth oxide region 44b which is composed of mainly chromite is produced, as illustrated in FIGS. 5 and 6. As a result of the second heating treatment, the adjacent soft magnetic metal particles are bonded to each other via the insulation films formed on the respective surfaces thereof. In this manner, the base body 10, 110, or 210 in which the soft magnetic metal particles are bonded to each other is obtained.

Through the first heating treatment and the second heating treatment, the amorphous alumina mixed with the precursor powder is not transformed into crystalline alumina. Consequently, the amorphous alumina mixed with the precursor powder forms the first oxide region 41 in the base body 10, 110, or 210. Since high active energy is required to cut an alumina bond of amorphous alumina, the alumina bond in the fine amorphous alumina particles is not cut at a temperature of 900° C. or lower at which the first heating treatment and the second heating treatment are performed. Therefore, crystallization of the amorphous alumina does not occur in the production method in FIG. 8.

If the content ratio of Si is less than the content ratio of Al in the precursor powder, the thickness of the second oxide region 42a that is composed of mainly an Al oxide can be made thin even when Al contained in the precursor powder is almost completely oxidized by the first heating treatment and the second heating treatment. In a case where the content ratio of Al in the precursor powder is low and a portion of the surface of each soft magnetic metal particle is not covered with the second oxide region 42a, the region, of the surface of the soft magnetic metal particle, not covered with the second oxide region 42a is covered with the third oxide region 43a that is composed of mainly an Si oxide. Consequently, the thickness of the insulation film disposed on the surface of each soft magnetic metal particle can be made thin while the insulation performance among the soft magnetic metal particles is maintained.

Next, in step S7, the external electrode 21 and the external electrode 22 are formed on surfaces of the base body 10 obtained in step S6. The external electrode 21 is connected to one end of the coil conductor 25, and the external electrode 22 is connected to the other end of the coil conductor 25. The molded object having undergone the second heating treatment may be impregnated with the resin before the external electrodes 21 and 22 are formed. The molded object is impregnated with a thermosetting resin such as an epoxy resin, for example. Accordingly, the resin intrudes into gaps among the soft magnetic metal particles in the base body 10. Then, the resin having intruded in the base body 10 is cured, so that the mechanical strength of the base body 10 can be improved.

The coil component 1 is produced by the above-mentioned steps.

Also, the base body 310 can be produced by the production method in FIG. 8. To produce the base body 310, amorphous alumina formed into a flat shape is mixed in the precursor powder. Except for the feature in which the amorphous alumina is formed into a flat shape, the same production steps of the base body 10, 110, or 210 are performed for producing the base body 310.

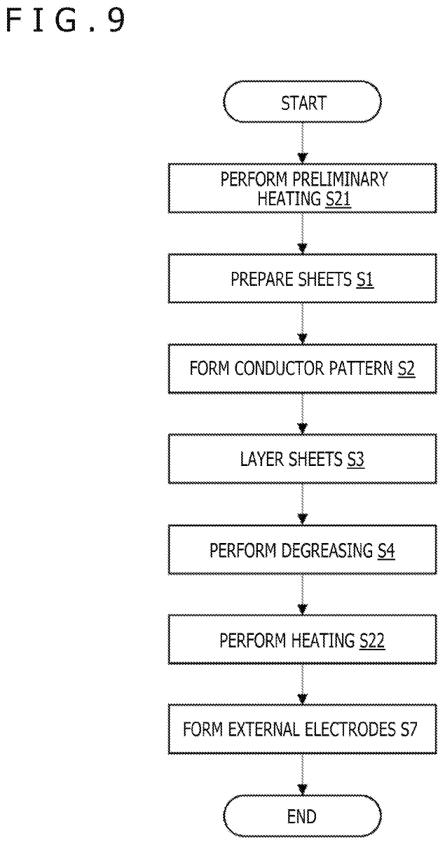

Next, another embodiment of the method for producing the coil component 1 will be explained with reference to FIG. 9. The production method in FIG. 9 differs from that in FIG. 8 in that, in the production method in FIG. 9, the precursor powder is preliminarily heated prior to preparation of the magnetic material sheets and an oxide of Si is produced on the surface of the precursor powder through the preliminary heating.

As depicted in FIG. 9, first, in step S21, the precursor powder which is a raw material of the soft magnetic metal particles is prepared, and is preliminarily heated. The preliminary heating is performed at a temperature of lower than 500° C. for six to 15 hours. As a result of the preliminary heating, an oxide of Si is discretely produced on the surface of the precursor powder. With the precursor powder on the surface of which the oxide of Si is discretely formed, steps S1 to S3, which are the same steps in FIG. 8, are performed. Accordingly, the molded object of the layered magnetic material sheets is produced. In step S4, the molded object is degreased.

Next, in step S22, heating treatment is performed on the degreased molded object. The heating treatment in step S22 is performed under the same condition as that of the second heating treatment in step S6 in FIG. 8. As a result of the second heating treatment, the element A (e.g., Al) in the precursor powder contained in the molded object is oxidized, and an oxide of the element A is produced. Accordingly, soft magnetic metal particles whose surfaces are covered with insulation films are produced from the precursor powder. In the heating treatment in step S22, the adjacent soft magnetic metal particles are bonded to each other via the insulation films formed on the respective surfaces thereof. In this manner, the base body 310 in which the soft magnetic metal particles are bonded to each other is obtained.

Next, in step S7, the external electrode 21 and the external electrode 22 are formed on surfaces of the base body 310 obtained in step S22. Through the above-mentioned steps, the coil component 1 is produced.

The dimensions, materials, and arrangement of the constituents having been explained in the above-mentioned embodiments are not limited to those explicitly indicated in the embodiments. These constituents can be modified to have desired dimensions, materials, and arrangement that can fall within the scope of the present technology.

A constituent that is not explicitly described in the present description can be added to each of the above-mentioned embodiments, and any one of the constituents having been explained in the above-mentioned embodiments can be omitted.

The expressions “first, ” “second, ” “third, ” etc., in the present description are intended to discriminate among the constituents, and are not intended to necessarily limit the number, the order, or the contents thereof. In addition, a reference numeral for identifying a constituent is used in each context. A reference numeral that is used in one context may denote a different constituent in another context. In addition, a constituent denoted by a certain reference numeral can additionally have the function of a constituent denoted by another reference numeral.

The present description also discloses the following technology.

### Supplementary Note 1

A magnetic base body including:
a plurality of soft magnetic metal particles each containing Fe; and
a plurality of insulation films that cover respective surfaces of the plurality of soft magnetic metal particles, in which
the plurality of soft magnetic metal particles include a first soft magnetic metal particle,
the plurality of insulation films include a first insulation film that covers a surface of the first soft magnetic metal particle, and
the first insulation film is disposed between the first soft magnetic metal particle and a soft second magnetic metal particle that is adjacent to the first soft magnetic metal particle, and the first insulation film includes a first oxide region that is composed of mainly an amorphous Al oxide and a second oxide region that covers a portion of the surface of the first soft magnetic metal particle and that is composed of mainly an oxide of an element A.

### Supplementary Note 2

The magnetic base body according to [Supplementary note 1], in which
the first oxide region covers a first surface region that is a portion of the surface of the first soft magnetic metal particle, and
the second oxide region covers a second surface region that is a portion, of the first soft magnetic metal particle, different from the first surface region.

### Supplementary Note 3

The magnetic base body according to [Supplementary note 1] or [Supplementary note 2], in which
the plurality of soft magnetic metal particles further include a third soft magnetic metal particle that is adjacent to the first soft magnetic metal particle and a fourth soft magnetic metal particle that is adjacent to the second soft magnetic metal particle and the third soft magnetic metal particle, and
the first oxide region is disposed between the first soft magnetic metal particle and the second soft magnetic metal particle and between the third soft magnetic metal particle and the fourth soft magnetic metal particle.

### Supplementary Note 4

The magnetic base body according to any one of [Supplementary note 1] to [Supplementary note 3], in which,
in a cross section of the magnetic base body taken along a plane passing through the first soft magnetic metal particle, an area of the first oxide region occupies 2% or less of a total area of the cross section.

### Supplementary Note 5

The magnetic base body according to any one of [Supplementary note 1] to [Supplementary note 4], in which
the first oxide region further contains at least one oxide selected from a group consisting of an amorphous Si oxide, an amorphous Ca oxide, and an amorphous Mg oxide.

### Supplementary Note 6

The magnetic base body according to any one of [Supplementary note 1] to [Supplementary note 5], in which
the first insulation film further includes a third oxide region that covers a third surface region, of the soft magnetic metal particle, different from the first surface region and the second surface region and that is composed of mainly an Si oxide.

### Supplementary Note 7

The magnetic base body according to any one of [Supplementary note 1] to [Supplementary note 6], in which
the first insulation film further includes a fourth oxide region that contains FeCr₂O₄.

### Supplementary Note 8

The magnetic base body according to any one of [Supplementary note 1] to [Supplementary note 7], in which
a content ratio of Fe in each of the plurality of soft magnetic metal particles is 95 wt % or higher.

### Supplementary Note 9

The magnetic base body according to any one of [Supplementary note 1] to [Supplementary note 7], in which
the element A is more susceptible to oxidation than Fe.

### Supplementary Note 10

A coil component including:
the magnetic base body according to any one of [Supplementary note 1] to [Supplementary note 9]; and
a coil conductor provided to the magnetic base body.

### Supplementary Note 11

A circuit board including:
the coil component according to [Supplementary note 10].

### Supplementary Note 12

An electronic apparatus including:
the circuit board according to [Supplementary note 11].

It should be understood by those skilled in the art that various modifications, combinations, sub-combinations and alterations may occur depending on design requirements and other factors insofar as they are within the scope of the appended claims or the equivalents thereof.

What is claimed is:

1. A magnetic base body comprising:
a plurality of soft magnetic metal particles each containing Fe; and
a plurality of insulation films that cover respective surfaces of the plurality of soft magnetic metal particles, wherein
the plurality of soft magnetic metal particles include a first soft magnetic metal particle,
the plurality of insulation films include a first insulation film that covers a surface of the first soft magnetic metal particle, and
the first insulation film is disposed between the first soft magnetic metal particle and a soft second magnetic metal particle that is adjacent to the first soft magnetic metal particle, and the first insulation film includes a first oxide region that is composed of mainly an amorphous Al oxide and a second oxide region that covers a portion of the surface of the first soft magnetic metal particle and that is composed of mainly an oxide of an element A.

2. The magnetic base body according to claim 1, wherein
the first oxide region covers a first surface region that is a portion of the surface of the first soft magnetic metal particle, and
the second oxide region covers a second surface region that is a portion, of the first soft magnetic metal particle, different from the first surface region.

3. The magnetic base body according to claim 1, wherein
the plurality of soft magnetic metal particles further include a third soft magnetic metal particle that is adjacent to the first soft magnetic metal particle and a fourth soft magnetic metal particle that is adjacent to the second soft magnetic metal particle and the third soft magnetic metal particle, and
the first oxide region is disposed between the first soft magnetic metal particle and the second soft magnetic metal particle and between the third soft magnetic metal particle and the fourth soft magnetic metal particle.

4. The magnetic base body according to claim 1, wherein,
in a cross section of the magnetic base body taken along a plane passing through the first soft magnetic metal particle, an area of the first oxide region occupies 2% or less of a total area of the cross section.

5. The magnetic base body according to claim 1, wherein
the first oxide region further contains at least one oxide selected from a group consisting of an amorphous Si oxide, an amorphous Ca oxide, and an amorphous Mg oxide.

6. The magnetic base body according to claim 2, wherein
the first insulation film further includes a third oxide region that covers a third surface region, of the soft magnetic metal particle, different from the first surface region and the second surface region and that is composed of mainly an Si oxide.

7. The magnetic base body according to claim 1, wherein
the first insulation film further includes a fourth oxide region that contains FeCr₂O₄.

8. The magnetic base body according to claim 1, wherein
a content ratio of Fe in each of the plurality of soft magnetic metal particles is 95 wt % or higher.

9. The magnetic base body according to claim 1, wherein
the element A is more susceptible to oxidation than Fe.

10. A coil component comprising:
the magnetic base body according to claim 1; and
a coil conductor provided to the magnetic base body.
